(19) United States
(12) Patent Application Publication
(10) Pub. No.: US 2010/0103779 A1
(43) Pub. Date: Apr. 29, 2010

(54) EVENT-BASED REMINDER SYSTEM

(76) Inventors: Manjusha Kakirde, Gurgaon (IN); Arjun Roychowdhury, Gurgaon (IN)

Correspondence Address: BAKER & DANIELS LLP, 300 NORTH MERIDIAN STREET, SUITE 2700, INDIANAPOLIS, IN, 46204, US

(21) Appl. No.: 12/532,579

(22) PCT Filed: Feb. 21, 2008
(86) PCT No.: PCT/IN08/00101

§ 371 Date: Sep. 22, 2009

(30) Foreign Application Priority Data
Feb. 21, 2007 (IN) 363/DEL/2007

(51) Int. Cl. G04B 47/00; H04M 3/00; G06F 15/16

(52) U.S. Cl. 368/10; 455/418; 709/206

(57) ABSTRACT

An Event-Based Reminder System that can be used for setting prompts to become active at instances specific to the device into which it is installed. More particularly, it pertains to handheld and communication devices for example contemporary mobile phones, wherein there is a need for a reminder system that goes beyond the calendar based ones and removes the rigidity of associating a time and date for each required event

### FIELD OF THE INVENTION

The present invention discloses a new technique and tool for the same, an Event-Based Reminder System that can be used for setting prompts to become active at instances specific to the device into which it is installed. More particularly, it pertains to handheld and communication devices for example contemporary mobile phones, wherein there is a need for a reminder system that goes beyond the calendar based ones and removes the rigidity of associating a time and date for each required event.

### BACKGROUND OF THE INVENTION

In the current scenario, the kind of reminder service available on handheld and communication devices is restricted to being calendar based. The date and time combination decides the activation of the reminder. Hence, this reminder service is not context based, nor does it allow utilization of other event occurrences not related to a calendar system to be utilized for the reminder service. There are scenarios in which the user may wish to be alerted of an event, or perform an action based on an event which is not time-bound. For example: Joe hopes that he remembers to ask his mother for the recipe of a Christmas cake the next time he calls her, or she calls in. In this situation, when his mother calls him, or he places a call to his mother, he would like to get an on-screen reminder saying “Remember to ask her for recipe” or a similar message. This situation, therefore, cannot be evaluated in terms of a precise date and time. Thus, his requirement is context based and not time based. Here there is a need for a context or event based alert service.

US patent US20060208861 relates to Actionable Communication Reminders and describes techniques and tools for providing actionable communication reminders. For example, an item representing an original communication is displayed and a command to set up a reminder to respond to the original communication is accepted. The reminder is set up and, at a later time, is displayed. An input mechanism that can be actuated to respond to the communication may be provided at the later time. As another example, a suggested time to display the reminder and suggested contact information for responding to the original communication are displayed while setting up a reminder. However, this invention does not take note of reminders for those situations wherein the date and time are not known in advance and are more likely suited for event based reminding. This feature is offered in the instant invention.

US patent US20060220799 relates to A Method, System, and Computer Program Product for Providing an Intelligent Event Notification System. The method includes selecting a type of event notification for an event. Determining the type of event notification is based in part on information elements associated with the event. The method also includes determining at least one optimal alert system to receive an event notification corresponding to the type of event notification selected. The determination is based in part on information elements associated with the event. The method further includes associating an alert trigger with the event notification and transmitting the event notification to the at least one optimal alert system upon activation of the alert trigger. Here also, even though the invention offers lots of useful features, it still makes use of calendaring applications to associate a time and date with any reminder being set up for an event. It makes it essential for the user to know a time and date for each event he needs to be reminded of. It does not cater to events that happen without the time to be known in advance. These events are nevertheless, covered by the instant invention.

### SUMMARY OF THE INVENTION

It is an object of the instant invention to obviate the above drawbacks and provide a method and system for performing tasks and alerting the user on the basis the occurrence of events.

To achieve the aforementioned objectives, the invention provides a system for implementing an event-based reminder system for handheld and communication devices, said system comprising plurality of input means to receive information from the user at various stages of setting up the reminder, a storage unit to store the said information; processing means configured to wait for each of the said stored events and accordingly activate the corresponding reminder in the stated manner; and a plurality of output means to alert the user when said event occurs.

The instant invention further provides a method for implementing an event-based reminder system for handheld and communication devices, said method comprising the steps of receiving the event type on occurrence of which the user must be alerted via input means, receiving the alert type which needs to be activated once said event occurs via input means, storing said set preferences in the storage unit, waiting for said event to occur using the configured processing means, and alerting the user as set when said event occurs through the corresponding output means

The instant invention further provides a method for implementing an event-based reminder system for handheld and communication devices, said method comprising the steps of receiving the event type on occurrence of which a task must be performed via input means, specifying the task to be performed when said event occurs, storing said set preferences in the storage unit, waiting for said event to occur using the configured processing means, and performing the said task when said event occurs.

The present invention discloses an event-based reminder application. It is an improvement over the existing calendar-based reminder services offered in many devices particularly handheld and communication devices such as mobile phones etc. It goes over and above the existing features and offers the added advantage and flexibility of setting reminders based on events rather than date and time. The events here can be any activity specific to that device or a combination of more than one. It thus encompasses a wider scope and proposes a larger variety to serve as basis to be reminded of a certain task to be performed. It also acts user-friendlier by associating tasks with device features rather than simple calendar date and time.

The events chosen by the user act as triggers to display the reminder note set by the user right at the instant when the user chooses to be reminded. Since, the time of the instant may not be known it fulfills the need of situation-dependent reminders. This makes the instant invention context sensitive and specific to the device it is working on. Further, in traditional applications, the reminder service is dependent on the preciseness of date and time set by the user. But, in the instant invention, the reminder service is simply dependent on the event chosen to act as a trigger and hence delivers a better service to the user.

### BRIEF DESCRIPTION OF DRAWINGS

FIG. 1 illustrates a flowchart depicting the basic operation of the instant invention

FIG. 2 illustrates a flowchart depicting an embodiment of the instant invention

FIG. 3 illustrates a system architecture diagram for the instant invention

FIG. 4 describes the system architecture of the invention

### DETAILED DESCRIPTION OF THE INVENTION

The reminder service of the present invention integrates event parameters with the corresponding device activities that act as triggers. It offers a better and improvised reminder service with varied event parameters relating to basic events that occur during the usage of concerned device. These basic supported events, for example, relating to a mobile phone, may include incoming call event, outgoing call event, incoming SMS, outgoing SMS, switch-on mobile, switch-off mobile and change in mobile network in combination with the existing date and time event. The reminder is set selecting one or more of these events. Additional information may be required for some events such as the mobile number must be specified for setting a reminder based on an incoming or outgoing SMS or call. Once, the event selection procedure completes, the user needs to specify the reminder note to be flashed once the chosen criteria is fulfilled. In case the event parameter is selected as an incoming call then the reminder note is flashed as the phone rings intimating the user that a call needs to be received. This is done in order to remind the user of the activity that needs to be performed pertaining to that call, just before he attends the call. Thus, it is efficient and user-friendly as it reminds the user about the task to be performed just when it needs to be performed.

This service may not be limited to just flash the reminder note of the screen. It can be customized to incorporate alternate ways of alerting the user to suit his requirements. For example, if the reminder note is not descriptive enough, then icons and pictures may also be displayed to satisfactorily remind the user of the deed to be done. Also, going a step further, the task may also be performed automatically without bothering the user to be performed by him. For example, a SMS may be sent to desired person alerting that the user is switching off his phone when the related even occurs.

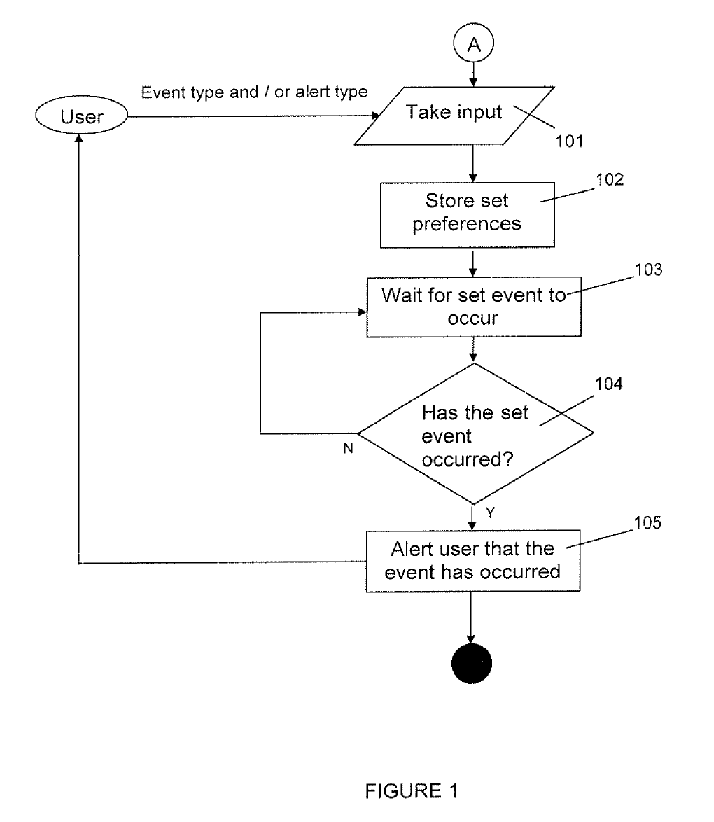

FIG. 1 defines the basic operation of the instant invention. When the user activates the reminder system, in step 101, the handheld device requests for user input pertaining to the selection of the event, on the occurrence of which the user wishes to be alerted. This selection can be chosen from a list of available options. This list may also be customized to suit the user's needs. The event type may be one of ‘switching-on device’, ‘switching-off device’. These events do not require any additional information from the user. However, events such as ‘sending SMS’, ‘receiving SMS’, ‘making a call’, ‘receiving a call’ and the like require additional information such as the number on which the SMS/call is to be sent/made/received. The event may also be described as date and time the parameters as is done in conventional systems. This information is also asked for, from the user by the device and taken as input. The user may also select more than one event on the occurrence of which he should be alerted.

The device then prompts the user to select the manner in which he wants to be alerted when the chosen event occurs. This also is selected from a ready list of options, customizable as desired by the user. The alert type may be alerts such as an alarm or flashing a reminder note or a combination of both. In case a reminder note is to be flashed as an alert, the said note is taken as input from the user.

Next, in step 102, the event selected by the user along with the chosen manner of alerting him is stored in the memory of the device. These set preferences are configurable at any point of time by the user. They may also be viewed in his organizer when he so wishes. Also, any customizations made to the available list of events and alerts are also maintained for future use.

Further, in steps 103 and 104, the device waits for the event to occur as defined by user in the background and its normal functioning continues in the foreground. The user may use the device for other purposes.

Once the event has occurred, the device senses it and in step 105 it alerts the user in the configured manner. For instance, if the user wishes for an alarm to sound when the operating network changes, the set alarm tone is sounded when it detects a change in the operating network.

The device may also maintain a log of when the selected events occurred and how the user was alerted. In this manner, the user can keep track of all his alerts and may reactivate them. This option is customizable by the user wherein he may choose the number of entries the device saves, the fields which he requires etc.

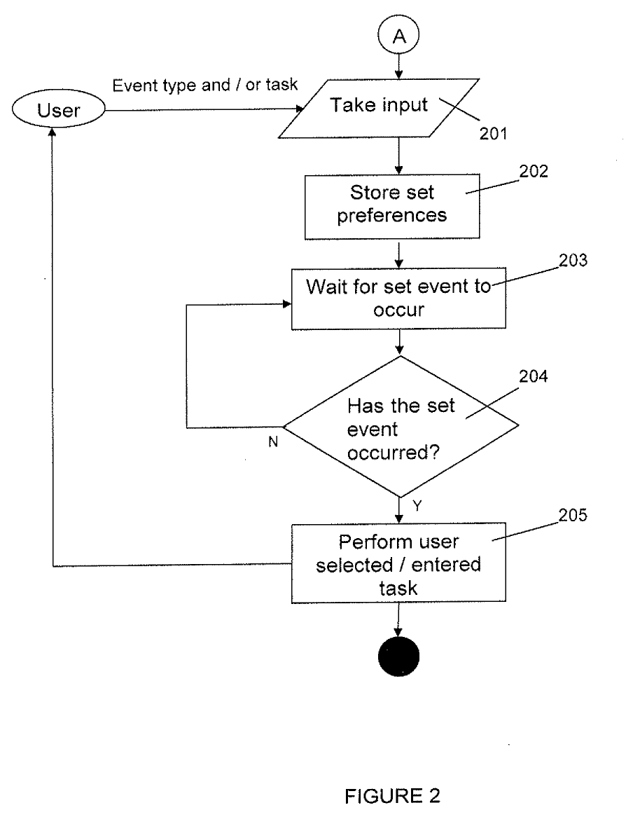

Similarly, FIG. 2 defines an embodiment of the instant invention. When the user activates the reminder system, in step 201, the handheld device requests for user input pertaining to the selection of the event, on the occurrence of which the user wishes a task to be performed. The selection is made in the same manner as described in step 101 of FIG. 1.

The device then prompts the user to select the task to be automatically performed once the chosen event occurs. This also is selected from a ready list of options, customizable as desired by the user. The task type may be functionalities of the device. Tasks such as ‘switch-off device’ and the like do not require any additional information from the user. However, tasks such as ‘send SMS’ and the like require additional information such as the number on which the SMS is to be sent. This information is also asked for, from the user by the device and taken as input. The user may also select more than one task to be performed on the occurrence of his chosen event and also specify the order in which they are to be performed.

Next, in step 202, the device stores the set inputs and preferences in the same manner described in FIG. 1. Further, in steps 203 and 204, the device waits for the event to occur as defined for FIG. 1.

Once the event has occurred, the device detects it and in step 205 it performs the task as set by the user in the configured manner. For instance, if the user wishes for the device to switch off if receives a call from a defined number, the device turns off on detecting an incoming call from the same.

The device may also maintain a log of when the selected events occurred and what task was performed. In this manner, the user can keep track of the tasks that have been performed automatically by the device and may reactivate them. This option is customizable by the user wherein he may choose the number of entries the device saves, the fields which he requires etc.

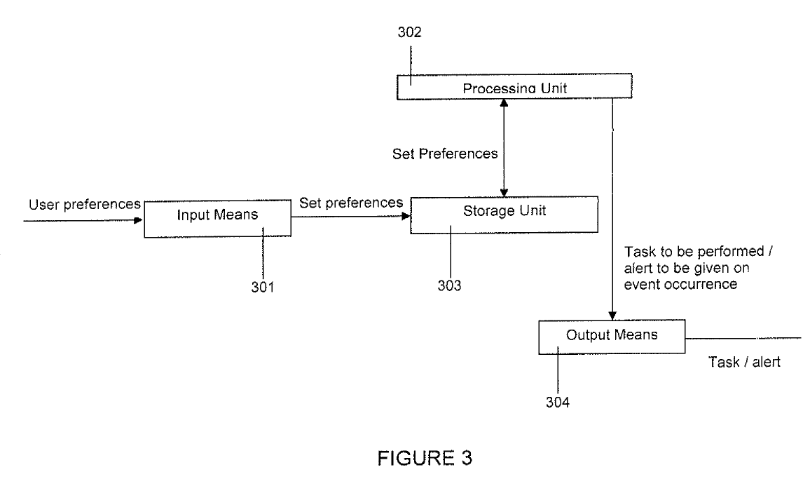

FIG. 3 illustrates a block diagram representing the various units comprising the system claimed in the instant invention. Unit 301 depicts the input means through which the user enters data into the system. This includes the event type, alert type and task selected by the user. This also includes the additional information required for particular event, alert and task types. Further, this input also may be the new events, alerts and tasks the user wants to add to the existing list. This input also includes customization data the user provides the device at any stage of operation. The input device may be more than one and of multiple types.

Unit 302 is the processing unit which keeps track of all the events that are awaited and the corresponding alerts to be given or tasks to be performed. It waits for the stored events to occur in the background and detects them when they happen. It also continues normal functioning of the device in the foreground so that the user may use the device as required.

Unit 303 depicts the storage unit that stores the preferences and configuration date set by the user. It also stores the log of the tasks performed by the device and the alerts given to the user.

Unit 304 is the output means. The output means flashes or announces the alert when the selected event occurs. The output device may be more than one and of multiple types.

Without limitations, the present invention also encompasses variations and modifications that will achieve the following:
The application developer is not tied to a particular programming language or platform
The system allows arbitrary extensions of rules and attributes that developers can use to extend the functionality
Any newly added functionality does not break existing functionality
It follows an implementation path which reuses existing and commonly found software/solutions on handheld and communication devices

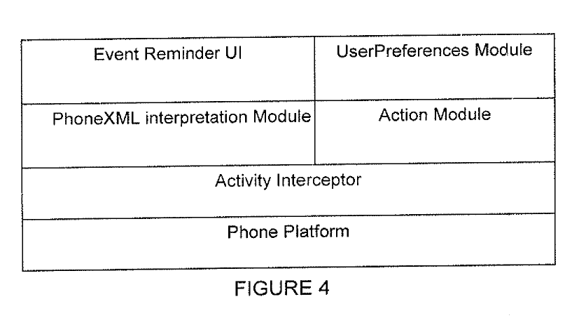

FIG. 4 describes the system architecture of the invention The Phone Platform is the default API/programming SDK provided by the device on which this invention is to be implemented. It is expected that this SDK will provide all the functionality required to interface with the physical phone.

The Activity Interceptor is the module which is invoked when the device receives or sends any event (like SMS, call, email etc.). This is required so that incoming/outgoing events are passed to the system to see if it matches any rules defined.

The PhoneXML interpretation Module is the module which is called by the Activity interceptor for any incoming/outgoing event. This module executes and locally created rules and tries to match them to the received/sent event under question. If there is no match, the control is transferred back to the device. If there is a match, the action module is invoked.

The Action Module is the module which executes a specific action on a rule match for the event under investigation. The action may be to render a message, send an SMS, make a call or any other action specified by the rule matched. One the action is executed, control is transferred back to the device for usual operation.

The User Preferences Module is the module which stores local rules that are created by the user. These rules are parsed by the PhoneXML interpretation module for a match as described before. The User Preference Module stores these rules in any persistent storage offered by the device in question (this could be flash memory, internal hard disk, or others).

The Event Reminder UI is a user interface which the user creates event reminders (rules). The exact GUI interface depends on the implementer's choice.

It is to be noted that while this document describes the overall architecture above, it does not matter exactly how the different modules above are physically implemented, what programming language is used or what architecture model (threaded, sequential, hybrid etc.) is implemented. By specifying the event reminder system in XML, as an XSD, we can leave the choice of architecture up to the implementer, which vastly improves portability and usability of this solution.

### XSD Specification of the Event Reminder System

This section specifies the XSD of the present invention. The XSD has been titled “PhoneXML”. It is expected that this XSD will be enhanced continuously to add new attributes.

<?xml version=“1.0” encoding=“UTF-8”?>
<xs:schema xmlns:xs=“http://www.w3.org/2001/XMLSchema”>

<xs:complexType name=“ActionType”
abstract=“true”></xs:complexType>
<xs:element name=“action”
type=“ActionType”></xs:element>
<xs:complexType name=“SwitchType”
abstract=“true”></xs:complexType>
<xs:element name=“switch”
type=“SwitchType”></xs:element>
<xs:element name=“sub” type=“SubAction”></xs:element>
<xs:element name=“expiry” type=“Expiry”></xs:element>
<xs:complexType name=“Expiry”>

<xs:sequence>

<xs:choice>

<xs:element name=“actionOccurance”>

<xs:simpleType>

<xs:restriction base=“xs:positiveInteger”>

<xs:minInclusive value=“1”></xs:minInclusive>

</xs:restriction>

</xs:simpleType>

</xs:element>
<xs:element name=“expiryDate”

type=“xs:date”></xs:element>

</xs:choice>

</xs:sequence>

</xs:complexType>
<xs:complexType name=“SmsSwitchType”>

<xs:complexContent>

<xs:extension base=“SwitchType”>

<xs:sequence>

<xs:element name=“From”

type=“AddressType”></xs:element>

<xs:element name=“To”

type=“AddressType“></xs:element>

<xs:attribute name=“time”

type=“xs:date”></xs:attribute>

<xs:attribute name=“receiverLocation”

type=“xs:string”></xs:attribute>

</xs:sequence>

</xs:extension>

</xs:complexContent>

</xs:complexType>
<xs:element name=“sms-switch” type=“SmsSwitchType”
substitutionGroup=“switch”></xs:element>
<xs:complexType name=“CallSwitchType”>

<xs:complexContent>

<xs:extension base=“SwitchType”>

<xs:sequence>

<xs:element name=“From”

type=“AddressType”></xs:element>

<xs:element name=“To”

type=“AddressType”></xs:element>

<xs:attribute name=“time”

type=“xs:date”></xs:attribute>

<xs:attribute name=“receiverLocation”

type=“xs:string”></xs:attribute>

</xs:sequence>

</xs:extension>

</xs:complexContent>

</xs:complexType>
<xs:element name=“call-switch” type=“CallSwitchType”
substitutionGroup=“switch”></xs:element>
<xs:complexType name=“MailSwitchType”>

<xs:complexContent>

<xs:extension base=“SwitchType”>

<xs:sequence>

<xs:attribute name=“url” type=“xs:anyURI”

use=“required”></xs:attribute>

<xs:attribute name=“time”

type=“xs:date”></xs:attribute>

<xs:attribute name=“receiverLocation”

type=“xs:string”></xs:attribute>

</xs:sequence>

</xs:extension>

</xs:complexContent>

</xs:complexType>
<xs:element name=“mail-switch” type=“MailSwitchType”
substitutionGroup=“switch”></xs:element>
<xs:complexType name=“DeviceStatusSwitchType”>

<xs:complexContent>

<xs:extension base=“SwitchType”>

<xs:sequence>

<xs:simpleType name=“DeviceState”>

<xs:restriction base=“xs:string”>

<xs:enumeration value=“OFF”></xs:enumeration>
<xs:enumeration value=“ON”></xs:enumeration>

</xs:restriction>
<xs:attribute name=“time”

type=”xs:date”></xs:attribute>

<xs:attribute name=“receiverLocation”

type=“xs:string”></xs:attribute>

</xs:simpleType>

</xs:sequence>

</xs:extension>

</xs:complexContent>

</xs:complexType>
<xs:element name=“deviceStatus-switch”
type=“DeviceStatusSwitchType”
substitutionGroup=“switch”></xs:element>
<xs:complexType name=“MailAction” minOccurs=“1”
maxOccurs=“unbounded”>

<xs:complexContent>

<xs:extension base=“ActionType”>

<xs:attribute name=“url” type=“xs:anyURI”

use=“required”></xs:attribute>

</xs:extension>

</xs:complexContent>

</xs:complexType>
<xs:element name=“mailAction” type=“MailAction”
substitutionGroup=“action”></xs:element>
<xs:complexType name=“SmsAction” minOccurs=“1”
maxOccurs=“unbounded”>

<xs:complexContent>

<xs:extension base=“ActionType”>

<xs:element name=“toReciever”

type=“string”></xs:element>

<xs:element name=“fromSender”

type=“string“></xs:element>

<xs:attribute name=“msg”

type=“string”></xs:attribute>

</xs:extension>

</xs:complexContent>

</xs:complexType>
<xs:element name=“sendSmsAction” type=“SmsAction”
substitutionGroup=“action”></xs:element>
<xs:complexType name=“CallAction” minOccurs=“1”
maxOccurs=“unbounded”>

<xs:complexContent>

<xs:extension base=“ActionType”>

<xs:element name=“toReciever”

type=“string”></xs:element>

<xs:element name=“fromCaller”

type=“string”></xs:element>

</xs:extension>

</xs:complexContent>

</xs:complexType>
<xs:element name=“callAction” type=“CallAction”
substitutionGroup=“action”></xs:element>
<xs:complexType name=“TextDisplayAction”>

<xs:complexContent>

<xs:extension base=“ActionType”></xs:extension>

</xs:complexContent>

</xs:complexType>
<xs:element name=“textDisplayAction”
type=“TextDisplayAction”
substitutionGroup=“action”></xs:element>
<xs:complexType name=“DeviceStateAction”>

<xs:complexContent>

<xs:extension base=“ActionType”>

<xs:simpleType name=“DeviceState”>

<xs:restriction base=“xs:string”>

<xs:enumeration value=“OFF”></xs:enumeration>
<xs:enumeration value=“ON”></xs:enumeration>

</xs:restriction>

</xs:simpleType>

</xs:extension>

</xs:complexContent>

</xs:complexType>
<xs:element name=“deviceStateAction”
type=“DeviceStateAction”
substitutionGroup=“action”></xs:element>
<xs:complexType name=“IncomingType”>

<xs:complexContent>

<xs:extension

base=“TopLevelActionType”></xs:extension>

</xs:complexContent>

</xs:complexType>
<xs:element name=“incoming” type=“IncomingType”
substitutionGroup=“toplevelaction”></xs:element>
<xs:complexType name=“OutgoingType”>

<xs:complexContent>

<xs:extension

base=“TopLevelActionType”></xs:extension>

</xs:complexContent>

</xs:complexType>
<xs:element name=“outgoing” type=“OutgoingType”
substitutionGroup=“toplevelaction”></xs:element>
<xs:complexType name=“NetworkChangeType”>

<xs:complexContent>

<xs:extension

base=“TopLevelActionType”></xs:extension>

</xs:complexContent>

</xs:complexType>
<xs:element name=“networkChange”
type=“NetworkChangeType”
substitutionGroup=“toplevelaction”></xs:element>
<xs:complexType name=“DeviceStatusType”>

<xs:complexContent>

<xs:extension

base=“TopLevelActionType”></xs:extension>

</xs:complexContent>

</xs:complexType>
<xs:element name=“deviceStatus”
type=“DeviceStatusType”
substitutionGroup=“toplevelaction”></xs:element>
<xs:complexType name=“TopLevelActionType”
abstract=“true”>

<xs:group ref =“Node”></xs:group>

</xs:complexType>
<xs:group name=“Node”>

<xs:choice>

<xs:element ref=“switch” minOccurs=“0”

maxOccurs=“1”></xs:element>

<xs:element ref=“sub” minOccurs=“0”

maxOccurs=“1”></xs:element>

<xs:element ref=“action” minOccurs=“0”

maxOccurs=“1”></xs:element>

<xs:element ref=“expiry” minOccurs=“0”

maxOccurs=“1”></xs:element>

</xs:choice>

</xs:group>
<xs:complexType name=“SubactionType”>

<xs:group ref=“Node”></xs:group>

</xs:complexType>
<xs:complexType name=“PhoneXmlType”>

<xs:sequence>

<xs:element name=“subaction” type=“SubactionType”

minOccurs=“0” maxOccurs = “unbounded”></xs:element>

<xs:element ref=“topLevelAction” minOccurs=“0”

maxOccurs=“unbounded”></xs:element>

</xs:sequence>

</xs:complexType>
<xs:element name=“phoneXml”
type=“PhoneXmlType”></xs:element>

</xs:schema>

The embodiments described above and illustrated in the figures are presented by way of example only and are not intended as a limitation upon the concepts and principles of the present invention. As such, it will be appreciated by one having ordinary skill in the art that various changes in the elements and their configuration and arrangement are possible without departing from the spirit and scope of the present invention as set forth in the appended claims.

It will readily be appreciated by those skilled in the art that the present invention is not limited to the specific embodiments shown herein. Thus variations may be made within the scope and spirit of the accompanying claims without sacrificing the principal advantages of the invention.

We claim:

1. A system for implementing an event-based reminder system for handheld and communication devices, said system comprising:
plurality of input means to receive information from the user at various stages of setting up the reminder;
storage unit to store the said information;
processing means configured to wait for each of the said stored events and accordingly activate the corresponding reminder in the stated manner; and
plurality of output means to alert the user when said event occurs

2. A system as claimed in claim 1, wherein said information includes event parameters

3. A system as claimed in claim 2, wherein said event parameters include the date and time the said event is expected to occur

4. A system as claimed in claim 2, wherein said event parameters relate to events that occur during the usage of the concerned device

5. A system as claimed in claim 4, wherein said event parameters include an incoming event

6. A system as claimed in claim 4, wherein said event parameters include an outgoing event

7. A system as claimed in claim 4, wherein said event parameters include switching-on the device

8. A system as claimed in claim 4, wherein said event parameters include switching-off the device

9. A system as claimed in claim 4, wherein said event parameters include a change in the operating network

10. A system as claimed in claim 2, wherein said event parameters include more than one event

11. A system as claimed in claim 2, wherein event parameters can be extended to create new definitions.

12. A system as claimed in claim 1, wherein said information includes additional information required for the selected event type

13. A system as claimed in claim 12, wherein said additional information includes a mobile number

14. A system as claimed in claim 12, wherein said additional information includes an email address

15. A system as claimed in claim 12, wherein said additional information includes an Instant Message address

16. A system as claimed in claim 1, wherein said information includes the choice of alert the wishes to use

17. A system as claimed in claim 1, wherein said information includes additional information required for the selected alert type

18. A system as claimed in claim 16, wherein said information is a reminder note

19. A system as claimed in claim 16, wherein said information is an alarm bell

20. A method for implementing an event-based reminder system for handheld and communication devices, said method comprising the steps of:
receiving the event type on occurrence of which the user must be alerted via input means;
receiving the alert type which needs to be activated once said event occurs via input means;
storing said set preferences in the storage unit;
waiting for said event to occur using the configured processing means; and
alerting the user as set when said event occurs through the corresponding output means

21. A method as claimed in claim 20, further comprising the step of entering additional information required for the event type selected

22. A method as claimed in claim 20, further comprising the step of specifying the reminder note to be flashed

23. A method as claimed in claim 22, wherein the said reminder note is announced

24. A method as claimed in claim 20, wherein a log of when the selected events occurred and how the user was alerted is maintained

25. A method as claimed in claim 24, wherein how said log is maintained is customizable

26. A method for implementing an event-based reminder system for handheld and communication devices, said method comprising the steps of:
receiving the event type on occurrence of which a task must be performed via input means;
specifying the task to be performed when said event occurs;
storing said set preferences in the storage unit;
waiting for said event to occur using the configured processing means; and
performing the said task when said event occurs

27. A method as claimed in claim 24, further comprising the step of entering additional information for the task selected

28. A method as claimed in claim 24, wherein said task includes sending an SMS to a desired number

29. A method as claimed in claim 24, wherein said task includes switching off the device

30. A method as claimed in claim 24, wherein said task includes changing the operating network

31. A method as claimed in claim 26, wherein a log of when the selected events occurred and which tasks were performed automatically is maintained

32. A method as claimed in claim 31, wherein the manner in which said log is maintained is customizable

33. A computer program product for implementing an event-based reminder system for handheld and communication devices, said computer program product comprising:
means configured to receive the event type on occurrence of which a task must be performed;
means configured to receive the task to be performed when said event occurs;
means configured to store said set preferences;
means configured to wait for said event to occur; and
means configured to perform the said task when said event occurs

34. A computer program product as claimed in claim 33, further comprising means configured to receive additional information for the task selected

35. A computer program product as claimed in claim 33, wherein said task includes sending an SMS to a desired number

36. A computer program product as claimed in claim 33, wherein said task includes switching off the device

37. A computer program product as claimed in claim 33, wherein said task includes changing the operating network

38. A computer program product as claimed in claim 33, wherein a log of when the selected events occurred and which tasks were performed automatically is maintained

39. A computer program product as claimed in claim 38, wherein the manner in which said log is maintained is customizable
